(19) United States
(12) Patent Application Publication
(10) Pub. No.: US 2026/0219292 A1
(43) Pub. Date: Jul. 30, 2026

(54) AUTOMATIC SYSTEM AND METHOD FOR GENERATING EMULSIFIED MEDIA AND EVALUATING OILY FILMS ON AQUEOUS SURFACES BY SPECTRAL IMAGING

(71) Applicants: PETRÓLEO BRASILEIRO S.A. - PETROBRAS, RIO DE JANEIRO (BR); SERVIÇO NACIONAL DE APRENDIZAGEM INDUSTRIAL – SENAI/RJ, Rio de Janeiro (BR)

(72) Inventors: Antonio Augusto Fidalgo NETO, Rio de Janeiro (BR); Giovanni Bressiani PEDROSO, Rio de Janeiro (BR); Vinnicius Ferraço BRANT, Rio de Janeiro (BR); Victor Gabriel De Paula SAIDE, Rio de Janeiro (BR); Raquel Cavalcanti GALVÃO, Rio de Janeiro (BR); Leon De França NASCIMENTO, Rio de Janeiro (BR); Rogerio Mesquita De CARVALHO, Rio de Janeiro (BR); Felipe Rebelo LOPES, Rio de Janeiro (BR)

(73) Assignees: PETRÓLEO BRASILEIRO S.A. - PETROBRAS, RIO DE JANEIRO (BR); SERVIÇO NACIONAL DE APRENDIZAGEM INDUSTRIAL – SENAI/RJ, Rio de Janeiro (BR)

(21) Appl. No.: 19/456,275

(22) Filed: Jan. 22, 2026

(30) Foreign Application Priority Data
Jan. 30, 2025 (BR) 1020250018730

(51) Int. Cl. G01N 35/10; B01F 23/41; B01F 23/411; B01F 23/43; B01F 27/91; B01F 35/75; B01F 35/90; B01F 35/93; B01F 101/23; G01N 21/3577; G01N 21/359; G01N 35/00

(52) U.S. Cl. CPC G01N 35/10; B01F 23/4105; B01F 23/411; B01F 23/4145; B01F 23/43; B01F 27/91; B01F 35/7544; B01F 35/93; G01N 21/3577; G01N 21/359; B01F 2035/99; B01F 2101/23; B01F 2215/0427; G01N 2035/00346

(57) ABSTRACT

An automatic system and method for generating emulsified media and evaluating oily films on aqueous surfaces by spectral imaging, which aims at, more specifically, developing sample preparation processes, emulsion formation, simulation of disposal in an aqueous environment, detection and characterization of oily features in aqueous medium from an automated system that mimics field conditions, and that includes tests of repeatability. In general, the system includes (a) a formation tank, (b) a preparation tank, and (c) an automated and reproducible module, controlled by a digital interface, having the capacity to program protocols that generate emulsified systems that mimic real ones and allow their monitoring in a way that eliminates the subjectivity of the non-instrumental human evaluation. The system is particularly effective in its ability to generate emulsified media with known characteristics and inject the same into an aqueous medium in order to allow the study of the phenomenon.

### RELATED APPLICATION DATA

This application is based on and claims priority to Brazilian Application No. BR 10 2025 001873 0, filed on Jan. 30, 2025, the entire contents of which are incorporated herein by reference.

### FIELD OF THE INVENTION

The present invention falls within the technical field of oil and gas, and is related to the environmental monitoring and recovery, as well as water treatment and reuse technologies. More specifically, the invention relates to measurement technologies characterized by the use of optical techniques, and refers to an automatic system and method for generating emulsified media and evaluating oily films on aqueous surfaces by spectral imaging

### BACKGROUNDS OF THE INVENTION

The formation of oily films, also known as oily features, on the surface of water bodies is a relevant and potentially problematic phenomenon from an environmental point of view. However, there is a gap in their assertive evaluation and monitoring, in Brazil and worldwide, as will be seen below.

Despite the emergence of technical works addressing some of their aspects, in a relevant and laboratory environment, the complexity of the formation processes and the dynamics of the spreading of the oily films demands studies in a controlled system, precisely because of the need to understand the effect and extent (individual and synergistic) of the factors that are likely to generate this process. The main difficulty lies in the unavailability of objective systems and methods for characterizing this type of formation.

Since 1983, oily features have been classified based on the so-called Bonn Agreement, currently described by the ASTM F2534-17 standard, which uses apparent color as a parameter for classifying film thickness. However, problems arising from the subjectivity of this type of method hinder the monitoring of features, given that the type of oil, meteorological conditions, altitude and angle of observation, or even the color of the water can considerably affect the observed aspect.

Techniques and studies using remote sensing data are based on the optical properties of the oil spill and water. Typically, when a matter is illuminated with electromagnetic radiation, three main optical phenomena occur: reflection, transmission, and absorption. The physicochemical phenomenon must, however, consider aspects related to the chemical nature of the media and its effect on the scattering tendency under environmental variables.

It is noted that there are no technical reports (e.g., scientific papers or patent documents) that combine the sensing approach (which mainly uses satellite imaging) with chemical and petrochemical studies related to oils and produced water within the reality of offshore operations. The current methodology is, therefore, subjective in this case and not associated with initiatives based on satellite data.

Thus, the aforementioned challenges demand the development of analytical systems and methods capable of assertively measuring the thickness of oily features, which is directly related to the extent of the observed contamination, as well as distinguishing the origin of the material present in the oily film.

In view of the disclosure above, in order to solve the limitations and technical problems as previously described, an automatic system and method for generating emulsified media and evaluating oily films on aqueous surfaces by spectral imaging was developed, which is performed in a reproducible and controlled way, automating both processes. The system is particularly effective in its ability to generate emulsified media with known characteristics and inject the same into an aqueous medium in order to allow the study of the phenomenon.

Within the current methodological context, the ability to identify the bands of the Bonn protocol (ASTM F2534-17) is a differentiating factor, eliminating the subjectivity of assessments based on the human eye (which require experience and training on the part of the evaluator). After the results obtained by applying the use of the developed system and method, it was noted that in all measurements made and thickness predictions, there is >95% assertiveness in correctly identifying the band.

### STATE OF THE ART

The scientific paper titled “Remote sensing of marine oil slicks with hyperspectral camera and an extended database” is considered relevant because it addresses to the same demand for eliminating subjectivity and gaining reliability in measuring oily films on the water surface. Although it addresses to several matrices (different from the one that is the focus of the present invention), it includes an emulsified system that was evaluated by remote sensing.

It is noted that, although this document presents some similarities with the present invention, it differs in some aspects, such as, for example, the document operates with hyperspectral cameras (400-1000 nm and 1000-2500 nm) totaling 416 spectral bands versus three RGB bands, as described in the present invention. The data exploration, i.e., its concatenation and application, is distinct and makes use of both reflectance and light transmission, unlike the standardization described in the present invention. In addition, the use of different indices than those described herein is observed, with particular emphasis on the wavelengths evaluated in above-mentioned document, which differ from the typical RGB values. In the aforementioned document, the pixel resolution is between 2.8×5.6 mm (400-1000 nm) and 11.3×11.3 mm (1000-2500 nm) for laboratory sampling versus 0.81×0.81 mm (for 90 cm height) and 1.25×1.25 mm (for 1.37 m height) used in the present invention.

The aforementioned document uses reflectance values based on thickness estimation and not on individual pixel measurement or even a predetermined and parameterized quantity of pixels. The evaluation approach described herein is pixel-based (individual and with defined area) and object-based (with known total area). The authors of the paper admit that they were unable to perform the quantification, requiring data modeling for this purpose of analysis on the water surface, a step not yet developed or reported in the aforementioned document.

In addition, there is a lack of automation in the entire process of emulsion generation, introduction into the system, and acquisition of spectral data. The aforementioned document does not operate with a control system that evaluates samples (synthetic or real ones) of produced water or emulsions, since it focuses on oil spills and their detection on water surfaces.

In turn, document CN104154870B reports a method for measuring lubricating oily films (for application purposes to reduce abrasion) on solid surfaces, based on interference measurements from laser incidence at specific wavelengths. It is noted that the main similarity with the present invention is the working range and the precision obtained in the measurement, although the method, the application context, the material exemplified for the measurements and the measurement environment addressed to in the aforementioned document are distinct from those contemplated in the present invention.

In addition, it is important to emphasize that the evaluation of the search for thickness in the aforementioned document is associated with the formation of a lubricating oily film on the solid surface, in order to avoid erosive processes, that is, the surface area for evaluation, in addition to being reduced, is different from the present invention.

The scientific paper titled “Detection of oil Thickness and Emulsion Mixtures using Remote Sensing Platforms” is one of the consolidated references in the segment of remote sensing applied to monitoring oil spills on water, with a focus on identification and study through multiple complementary measurement approaches (i.e., drones, UAV units, and boat measurements). On the other hand, the present invention does not focus on oil spills or even operation in an environment with deduction, whether instrumental or mathematical, of the atmospheric interference for the evaluation of oily films. In addition, the scale of work can be highlighted, which in the aforementioned document is done via remote sensing and with a tank (at the National Oil Spill Response Research & Renewable Energy Test Facility, Ohmsett) that generate uncontrolled working and measurement conditions. This is due to the dynamic nature of this environment, which has luminosity and characteristics of the aquatic environment that are not controllable by the observers.

Further in this same sense, the aforementioned document operated with oil measurement methodologies (identified as Hoover Offshore Oil Pipeline System) in the Ohmsett tank by means of a single injection (1500 liters) of oil. In this procedure, the spreading and satellite measurements of the thickness of the film formed were evaluated. The present invention, however, operates with automated and controlled injections of oils, synthetic and real emulsions based on the context of production water disposal, and makes use of a robust methodology for the construction of a spectral database (based on replicates, diversity of experimental conditions and control parameters) that correlates these data with the chemical nature of the samples and their spreading patterns and the dynamics of the formation of the oily films on the water surface.

Finally, the scientific paper “Quantitative Characterization of Multiphase Mixtures Applied to Oil Spill Thickness Measurement” presents an innovative approach to the field measurement of oily films. To that end, however, it brings an approach opposite to that used in the present invention, both in terms of the technique used and the measurement strategy. The logic of measurement via capacitance requires the design of device prototypes that are launched into an open environment to come into contact with the medium containing an oily film, as opposed to the spectral and optical approach in which occur measurements without contact (regardless of the range of the electromagnetic spectrum used for the measurement). The authors of the aforementioned document describe the device shape and focus on the electrical schematics, focusing on the niche application in open sea.

Additionally, the measurements in the aforementioned document occur on the millimeter scale due to the (limited) sensitivity inherent in this contact measurement strategy, while the measurements reported in the present invention are made on the scale of 0.04-300 μm. Additionally, the test examples report various oils (Hidrocal, Calsol) that are not petroleum samples and even emulsified systems. This last one, because its matrix contains dynamic fractions of oil in water, behaves differently from the other compounds used as samples for capacitance measurements. It is further worth highlighting the limitations of “faradaic” techniques (including capacitance) in measuring saline systems.

As specified for each mentioned document, the main axes that differentiate the present invention are (a) the working matrix, since herein there is a focus on analyses of crude oils, post-water removal oils in the process routine and produced water samples containing characteristics of emulsified systems; (b) the form of spectral measurement, not related to the instrument and working range, but rather to the pixel dimension, the form of data processing and its use for oily films on the water surface; (c) the measurement sensitivity obtained by means of the strategy of automating the preparation and injection of the samples for subsequent data acquisition; (d) the ability to qualify and quantify emulsified systems containing minimum oil contents (beyond the usual demand reported in remote sensing work) and well below the current subjective via of identification (imprecise and with low reproducibility).

In view of the disclosure, it is further important to highlight that the present invention offers advantages over the state of the art, since it defines optimal parameters for disposal without the occurrence of features, and provides an evaluation of variables of oil composition, chemicals, concentration, total oil and grease (TOG) values, among others that may impact the formation of oily features. In addition to the reliability for quantifying the thickness of oily films formed by oily films, the ability to quantify emulsified systems that mimic the offshore context of produced water disposal is one of the great differentiators of the present invention.

### SUMMARY OF THE INVENTION

The present invention relates to an automated system and method for generating emulsified media and evaluating oily films on an aqueous surface by spectral imaging, which aims at, more specifically, developing sample preparation processes, emulsion formation, simulation of disposal in an aqueous environment, and detection and characterization of oily features in aqueous medium from an automated system that mimics field conditions, and which includes repeatability tests. In general, the system consists of (a) a formation tank, (b) a preparation tank and (c) an automated and reproducible module, controlled by a digital interface, having the capacity to program protocols that generate (in the formation tank) emulsified systems that mimic real ones and that allow their monitoring in order to eliminate the subjectivity of non-instrumental human evaluation. The system is particularly effective in its ability to generate emulsified media with known characteristics and inject the same into an aqueous medium, in order to allow the study of the phenomenon of formation of the oily features.

### BRIEF DESCRIPTION OF THE FIGURES

In order to obtain a complete and thorough visualization of the object of this invention, the figures to which reference is made are presented below.

FIG. 1 shows a schematic diagram of the system which is composed of the emulsion generation and injection module, water supply and recirculation. The system further contains pressure transmitters (PT), level transmitters (LT), flow transmitter and indicator (FIT), temperature indicator (TI), resistance controller (RC) and filters (FI).

FIG. 2 shows the imaging module positioned above the aqueous medium formation tank and which allows scanning of the water surface, according to a preferred configuration: aluminum profile (1), 45×90; sensor (2); camera fixing cart (3); movement system (4), linear guide, rack and pinion, aluminum profile (5), 45×45.

FIG. 3 shows a diagram with an integrated view of the system, according to a preferred configuration: wherein there is shown the modeling and prediction module (6), which can be a computer, where the report and analysis of spectral images are performed. It further shows the preparation tank (7), which can be heated by means of a controller (8). There is further a sample introduction tank (9), imaging metal structure (10), stepper motor (11), sensor (12); online/offline sampling (13), formation or imaging tank (14), lower inlet (15) and static mixer (16).

FIG. 4 shows TOG samplings performed by using an automated system for preparing and injecting emulsions into an aqueous medium.

FIG. 5 shows examples of droplet size distribution (DSD) analysis results for samples taken from the automated system for preparing emulsions.

FIG. 6 shows PCA plots exemplifying data grouping and the ability to differentiate oils (upper left) based on imaged values and their indices (upper right) with the automated system described herein. It further shows the classification in the Bonn Range for oil A (lower left) and B (lower right).

FIG. 7 shows an example of the appearance of the aqueous environment in which spectral data are obtained, followed by image processing, matrixing, and classification of the oily films. The acquired data is on the left, and the post-processing image is on the right.

### DETAILED DESCRIPTION OF THE INVENTION

The present invention relates to an automatic system for generating emulsified media and a method for evaluating oily films on an aqueous surface by spectral imaging, basically consisting of (a) a formation tank, (b) a preparation tank and (c) an automated and reproducible module, controlled by a digital interface, having the capacity to program protocols that generate (in the formation tank) emulsions that mimic real ones and allow their monitoring in order to eliminate the subjectivity of non-instrumental human evaluation. The system is particularly effective in its ability to generate emulsified media with known characteristics and inject the same into an aqueous medium, in order to allow the study of the phenomenon.

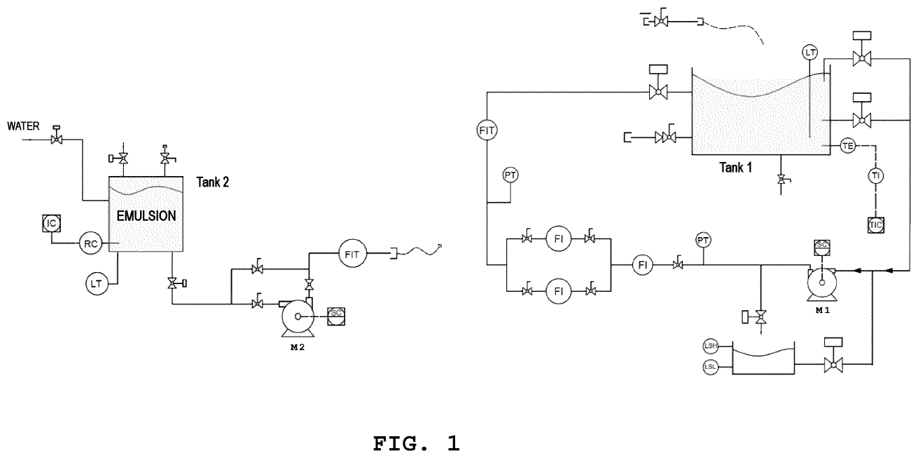

As shown in FIG. 1, the system comprises and is based on the articulation between two tanks of different dimensions and a metallic structure that provides the scanning of spectral sensor(s). The formation tank is a reservoir that can have dimensions of 240×120×110 cm (3 m³ total capacity and 2.8 m³ usable capacity) preferably made of polypropylene.

The formation tank acts as a mimic of a relevant environment in which oily films are observable due to oil leaks or controlled disposal of produced water. The preparation tank is a metal cylinder with a capacity of 150 L and a structure of 40×120 cm. Preferably, its composition is 316 stainless steel.

The preparation tank is used to generate the water and oil mixture, also called an emulsion. The connection between these tanks is made through an emulsion injection and water recirculation line.

The filling of the formation tank is done through a common 1,000 L cistern, made of polyethylene. The system is automated and activated by a supervisory system or set of instructions installed on a computer (Microsoft Windows system), making the human-machine interface intuitive and the process reproducible.

In this supervisory system, the formation and preparation tanks are visualized on a screen, and the system is monitored through level transmitters (LT), pressure transmitters (PT), and on-off valve activation. The main input variables are the pump speed and the height of the formation tank level. The pump speed is in the range of 6 to 7 L/min. The tank level height is between 0.5 and 1.0 m. The main purposes of this system are filling and draining water from the formation tank, as well as recirculation, where it is possible to pass the water from the formation tank through a set of three 20-inch (50.8 cm) filters (FI) each with a pleated filter element.

The filters (FI) ensure that the water will reach the formation tank and preparation tank without particulates. An important feature for the system is to ensure the height of the water column in the formation tank (preferably 100 cm) so that the imaging is always done with the same distance between the camera lens and the water level. Therefore, the system is also able to remove the necessary amount of water from the forming tank so that the height to be filled with emulsion remains the same.

Once the formation tank is at the ideal level for the experiment, the emulsion injection module is used to generate and subsequently add emulsion to the water that simulates the ocean, in this case, the formation tank. This emulsion injection module has a preparation tank, where crude oil is poured into saltwater to manufacture the emulsion.

From this point, the mixing procedure is carried out with the help of a constant speed disperser of 20,000 to 25,000 rpm and a mechanical mixer with a speed of up to 26,000 rpm. The mechanical mixer has a stainless steel structure that is connected to an electric motor. The propeller is positioned at a height of 60 cm at the preparation tank (approximately half the useful height of the preparation tank).

Once the mixing procedure is finished, an automated module is activated by software or a supervisory system, in which it is possible to choose the amount of emulsion that will be displaced to the formation tank. This displacement is carried out by a bronze centrifugal pump controlled by a proportional valve that opens and closes automatically depending on the amount of emulsion requested by the operator.

The system also has immersion electric heaters capable of heating the water in the preparation tank. In this way, it is possible to inject emulsions at ambient temperature and at temperatures up to 60° C. There are further 4 tubular heaters (3000 W) positioned in the formation tank.

Once the mixing process in the preparation tank is finished, the operator can choose to inject a controlled amount into the formation tank or recirculate a controlled amount of emulsion, causing it to exit the preparation tank, pass through the bronze centrifugal pump (pump M2 of the emulsion system, as shown in FIG. 1), be displaced to the static mixer and return to the preparation tank. In this way, it is possible to ensure better homogeneity of the medium, assertively control the characteristics of the emulsified medium, maintaining control over the stability and behavior of the emulsion.

Here, between 1.0 and 2.5 L of the emulsified system can be removed by the software or set of instructions (Elipse e3), followed by injections or injection cycles (equally automated) of known volume (e.g., 0.5-1.5 L). The cycles can be repeated until the volume stored in the tank is exhausted, as well as being done with controlled time gapping.

The injection of oil or emulsions into the formation tank containing an aqueous medium can be done from the upper portion (by means of a piping sequence positioned between 20 and 50 cm above the upper face of the main tank (formation tank)) or from the lower portion (near the base of the tank), with an automated control. Monitoring of the formed oily films can be done by means of sensors and cameras that have spectral evaluation capabilities from the visible range (including herein the use of RGB) to the near-infrared range.

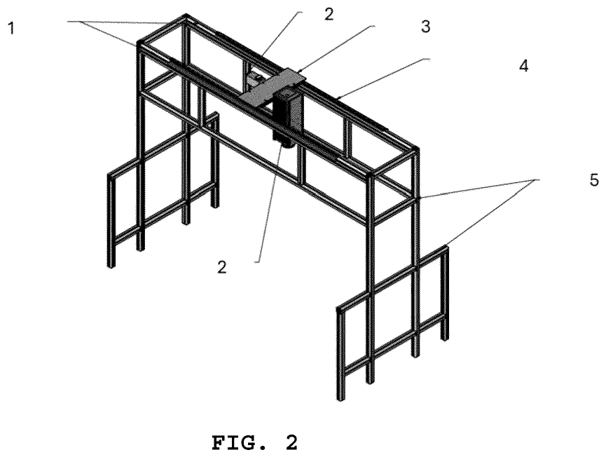

In all cases, a metal imaging structure (made of 40×40 structural aluminum profile) is positioned above the formation tank, in order to move in a controlled manner (by means of two Nema 34 stepper motors with 8.5 N·m torque and 4:1 planetary gearboxes) and with the sensor (2) positioned thereon (as shown in FIG. 2). Thus, 12000 cm² of the water surface can be observed, and the sensor (2) can be positioned between 90 cm and 1.37 m above this surface.

The imaging speed (preferably 1 cm/s), the resolution (preferably with pixels up to 1.5×1.5 mm) and the light intensity received by the sensor (preferably above 900 units) can be optimized, in order to capture the reflectance of the medium in relation to white (consisting of the aqueous medium without the presence of oil and the scanning of materials with high reflectance such as spectralon) or expected patterns. Up to 6000 W of power can be used, preferably with halogen light sources (an optional item, depending on the decrease in the standard deviation of the measurements).

The images are acquired automatically by using software (e.g., LUMO, ENVI, R script) for acquisition and control of frame rate and exposure rate. Finally, the files can be saved in various formats to generate a database or be automatically processed according to a chemical-mathematical analysis logic.

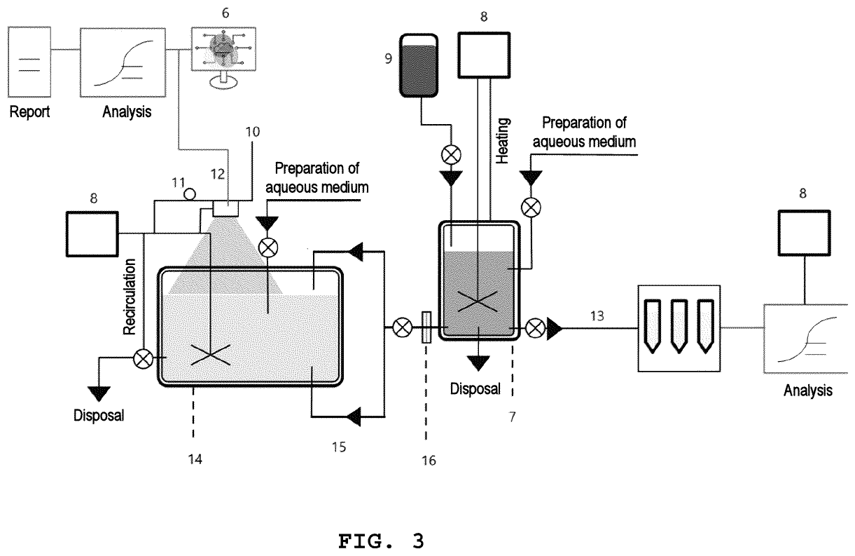

In order to unify the vision of the system, FIG. 3 illustrates the automatic system for generating emulsified media and evaluating oily films on aqueous surfaces by spectral imaging. As can be seen, there is inventiveness herein both in the hardware (due to its specifications), in the exemplified operating protocol, as well as in the generated data set and its use as an imaging medium for predicting oils and thicknesses.

Finally, mimicking the disposal of oil and emulsions within the reality of the O&G segment is part of the focus of this system. With a standard deviation of thickness measurements of 10% and reproducibility under emulsified system preparation conditions <10.0%, there is a robust system for studying the phenomenon (i.e., under variable conditions of stirring, temperature, presence of chemical additives) and evaluating oils with different physicochemical characteristics.

In summary, the method that occurs in the system comprises the following steps: a) preparation of the emulsified medium or samples in the preparation tank; b) standardization of the characteristics of the emulsified medium before the injection into the formation tank; c) execution, by the operator, of the sample injection protocol into the formation tank; d) activation of the metal structure for spectral acquisition of the formation tank, generating spectral images under optimized conditions; e) recording of spectral data and conversion into an editable file; f) processing, normalization of data and use in chemical-mathematical models; and g) processing and final result.

### Example of Embodiment

In order to validate the system and the method that occur in the system, tests were carried out, as will be seen in detail below. Firstly, in the step of preparation of the emulsified medium or sample (a), oil is weighed, in known mass, from 25 mg to 500 g, and subsequently transferred to a surge tank (preparation tank), the medium being filled with saline water (3.5%) in a volume of 144 L. Here, the system undergoes a step of shearing for 20 minutes, aiming at the formation of the emulsion in aqueous medium in the preparation tank. This process can be done with Turrax type equipment (at 25,000 rpm) and complementary or optional action of a mechanical stirrer (up to 26,000 rpm) for an equivalent or shorter time of up to three minutes.

This operation, which occurs in the step of standardizing the characteristics of the emulsified medium before the injection into the formation tank (b), is done by means of a control system that operates via supervisory software (set of instructions executable by computer). Through a computer, which communicates with a programmable logic controller, the Turrax and the mechanical stirrer are activated, in order to turn the equipment on or off according to the needs of the procedure.

At the end of the stirring, in step (c), the automated injection module conducts the liquid in the formation tank (containing up to 3000 L of water with 3.5% salinity), in the central portion of the water layer. The injection (between 0.5 and 80 L) takes place in up to 20 minutes, and the surface of the water layer is scanned (step d) by means of a pushbroom system, with a spectral sensor coupled to the metal structure positioned above (90° angle) the medium of interest.

This scan occurs at a height between 1.37 m and 90 cm, configurable according to the desired resolution, instrumental focus, and object to be observed. The speed is controlled in an automated and configurable way by means of a development board (Arduino system) that drives a stepper motor with a torque of 8.5 N·m. and 4:1 planetary gearboxes. At the end of the trajectory of interest, limit switches (physical element) and interrupt switches (virtual element programmed in Arduino) send a signal to the development board to end the movement.

In step d), the data are acquired online and passed to the image processor (e.g., Lumo Recorder or Python script), which saves the data in a predefined folder and directs the spectral information for processing via R script, Python, or ENVI software in order to execute the selection of “Regions of Interest”. Once the extraction is done by using a pixel-by-pixel or object-by-object approach, the data is then matrixed in The Unscrambler® X software, a Python script, or other free platforms for generating mathematical regressions.

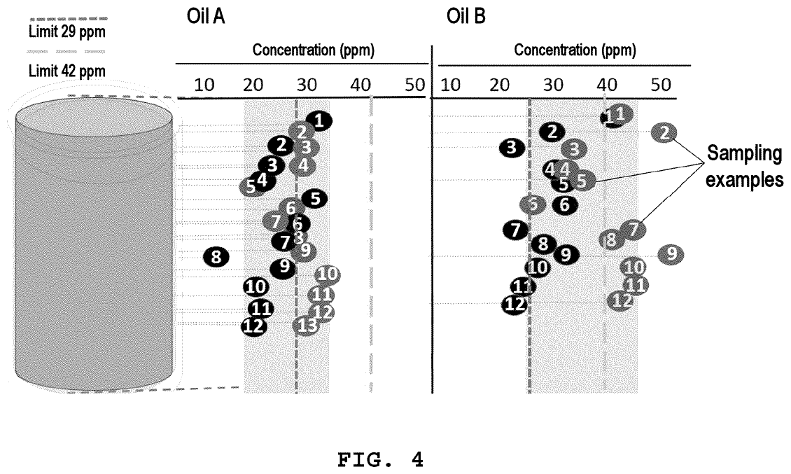

The samples are collected for evaluation of parameters such as TOG, as recommended by Brazilian resolution CONAMA No. 393. The volumes are sampled throughout the process, as required by experimental demand, by using the control system via Elipse, Laquis, or ScadaBR software, as shown in FIG. 4 for two oils. The average values obtained were 27.9±3.6 and 35.4±5.9, respectively for oils A and B.

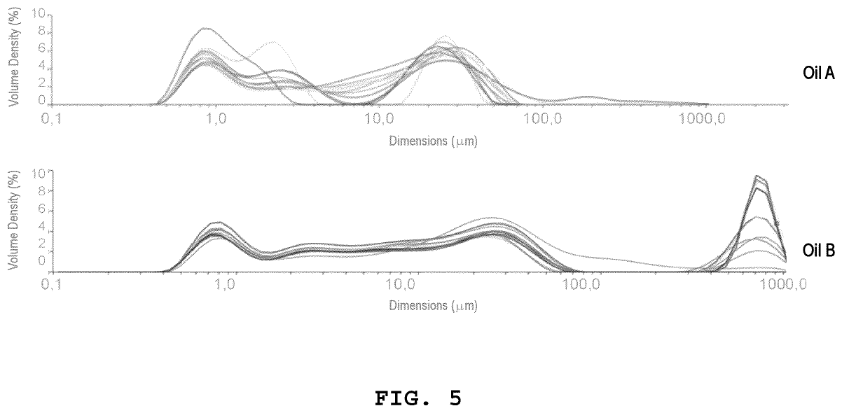

The additional evaluations include DSD evaluation (FIG. 5), which result in systems with specifications within the literature range of dispersed oil (15-150 μm) and free oil (>150 μm). The operation, in a reproducible manner (standard deviation between replicates <10%), is obtained from the operation described herein, for both ranges, being relevant when dealing with stable and unstable emulsified systems (which expands its application range). The DSD evaluation is performed on MASTERSIZER 3000 equipment and, together with the TOG parameter, is used as a response variable for correlation with spectral data.

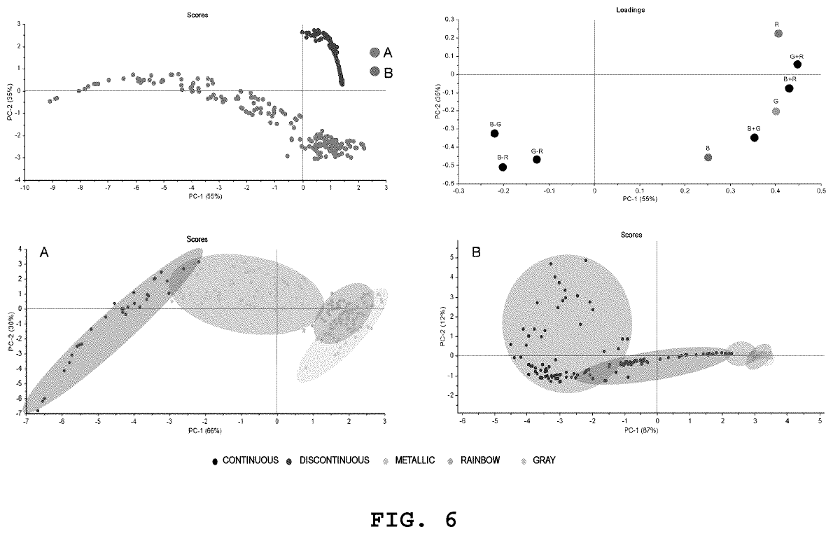

In step d), within the listed platforms, the saved data integrated into the matrices can be evaluated with analytical bias by means of groupings (main components) as illustrated in FIG. 6. The data are used in classification models such as LDA (linear discriminant Analysis) and SVM (Support Vector Machine) qualification/quantification, separated into calibration group (80% of the samples, randomly selected) and validation group (20% of the samples) of oils according to their physicochemical properties, which are understood in light of the spectral profile of each sample.

The same figure shows the PCA loading plot with the indices based on the RGB values, indicating the relevance of the values of each band and the indices related to the same for the identification of oils and emulsions. It further shows the classification in the Bonn Range for oil A (lower left) and oil B (lower right), with 95% reliability and low overlap of the regions grouped in each band, denoting the classification between thicknesses of 0.04 and 300 μm.

Here, in an approach that uses direct parameters (RGB and HSV) and indirect parameters (spectral indices derived from the direct values), there is the ability to classify oils with 100% assertiveness (Table 1) (within the range of specific masses of 800-980 kg/m³, ° APIs of 13-35, with interfacial tensions in a wide range of 12-26 nM/m).

TABLE 1
Oil prediction values from the
above-described approach

| | | Measured Values | |
|---|---|---|---|
| | | Oil A | Oil B |
| Predicted Values | Oil A | 100% | 0% |
| | Oil B | 0% | 100% |

Indexes can be understood as the employment of mathematical operations using the RGB channel values, namely: [B−R; B+R; (B−R)/(B+R); (B+R)/(B−R); G−R; G+R; (G−R)/(G+R); G−B; G+B; (G+B)/(G−B)], both inserted as input in the regression model for thickness prediction. For this purpose, the values are combined in regression format where the effects of each parameter mentioned above are independently defined and used for prediction.

Further in FIG. 6, the loading values clarify that there is an association between certain spectral bands and each exemplified oil, for example between the band “R” and the oil “B”, as a function of the parameterization obtained by the imaging system described herein.

Additionally, in step f), with the same spectral approach, groupings are made as a function of the thickness of the oily film, operating within the Bonn scale (ASTM F2534-17), being able to identify with 93.4% assertiveness in ranges, as shown in Table 2. It is noted that, with 95% reliability, and using 20% of the sampled values as a validation group, there is robustness in the performance of the system and method described herein.

TABLE 2
Bonn band prediction values from the above-described
approach

| | | Measured Values | | | | |
|---|---|---|---|---|---|---|
| | | Gray | Rainbow | Metallic | Discontinuous | Continuous |
| Predicted | Gray | 11 | 0 | 0 | 0 | 0 |
| Values | Rainbow | 1 | 13 | 1 | 0 | 0 |
| | Metallic | 0 | 1 | 16 | 0 | 0 |
| | Discontinuous | 0 | 0 | 0 | 18 | 0 |
| | Continuous | 0 | 0 | 0 | 2 | 11 |

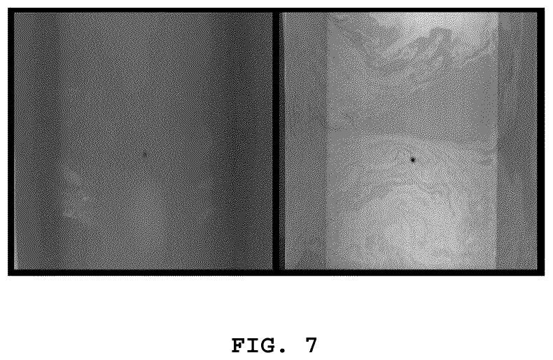

There is no methodology that eliminates subjectivity in the classification of oily film bands in an aqueous environment, resulting in a reliable and reproducible result as occurs in the present invention. Here, clearly depending on the capacity and configuration in which the system for oil preparation, injection and evaluation of oily films in a water layer operates. FIG. 7 illustrates the appearance of the system imaged from oil A, containing a known quantity of oil injected into the aqueous system.

Note the appearance (to the naked eye) of the tank on the left, with partial visualization of the oil spreading on the water surface, as well as the reconstructed image (on the right) after using the data clustering strategy (by RGB values and their indices), classification and quantification of the thicknesses of the dispersed oily films with models such as LDA and SVM, respectively.

Those skilled in the art will appreciate the knowledge presented herein and may reproduce the invention in the presented embodiments and in other variants, encompassed by the scope of the attached claims.

What is claimed is:

1. An automatic system for generating emulsified media and evaluating oily films on aqueous surfaces by spectral imaging, comprising:
a formation tank, with a function of acting as a tank mimicking a real environment;
a preparation tank, for generating emulsions;
an automated and reproducible module, controlled by a digital interface, wherein the automated and reproducible module has the capacity to program protocols that generate emulsions that mimic real emulsions; and
a metallic structure including sensors, level transmitters (LT), pressure transmitters (PT), on-off valves, a centrifugal pump, and filters (FI) with pleated filter elements, wherein the metallic structure located above the formation tank and moved in a controlled manner.

2. The system according to claim 1, wherein:
the formation tank is made of polypropylene, and
the formation tank is filled with water through a cistern.

3. The system according to claim 1, wherein the preparation tank is made of 316 stainless steel.

4. The system according to claim 1, wherein the formation tank and the preparation tank are connected through an emulsion injection and water recirculation line.

5. The system according to claim 1, wherein input variables are pump speed and height of the formation tank level.

6. The system according to claim 1, wherein the preparation tank comprises a disperser and a mechanical mixer for making the emulsion, and
wherein a propeller of the mechanical mixer is positioned at a height of 60 cm from the preparation tank.

7. The system according to claim 1, wherein the centrifugal pump assists in displacing the emulsion from the preparation tank to the formation tank.

8. The system according to claim 7, wherein the system further comprises immersion electric resistors to heat water in the preparation tank, and tubular resistors positioned in the formation tank, and
wherein displacing of emulsions occurs at ambient temperature and up to 60° C.

9. The system according to claim 1, wherein injection of oil or emulsions into the formation tank is done from an upper portion or a lower portion, with automated control.

10. The system according to claim 1, wherein formed oily films are monitored by sensors and cameras, and
wherein the sensors and cameras have spectral evaluation capability in the visible range and the near-infrared range.

11. The system according to claim 1, wherein the sensors of the metallic structure are positioned between 90 cm and 1.37 m above a surface of water in the formation tank.

12. The system according to claim 1, wherein a height of a water column in the formation tank is 100 cm.

13. An automatic method for generating emulsified media and evaluating oily films on aqueous surfaces by spectral imaging, comprises the following steps:
a) preparation of an emulsified medium in a preparation tank;
b) standardization of characteristics of the emulsified medium before injection into a formation tank;
c) execution, by an operator, of a sample injection protocol into the formation tank;
d) activation of a metal structure for spectral acquisition of the formation tank, generating spectral images under optimized conditions;
e) recording of spectral data and conversion into an editable file;
f) processing, normalization of data and use in chemical-mathematical models; and
g) processing and final result.

14. The method according to claim 13, wherein the operator:
chooses to inject a controlled quantity of emulsified medium into the formation tank, or
recirculates a controlled quantity of emulsified medium by causing the controlled quantity of emulsified medium to exit the preparation tank, pass through a bronze centrifugal pump, and be displaced to a static mixer and returned to the preparation tank.

15. The method according to claim 13, wherein steps f) and g) are executed by a set of computer-executable instructions.

16. The method according to claim 13, wherein, in step d), an imaging speed is 1 cm/s, a resolution with pixels is up to 1.5×1.5 mm, and a luminous intensity received by a sensor is above 900 units.
